(19) United States
(12) Patent Application Publication
(10) Pub. No.: US 2005/0013933 A1
(43) Pub. Date: Jan. 20, 2005

(54) Method of forming ion transport membrane composite structure

(76) Inventors: Hancun Chen, Williamsville, NY (US); Jack C. Chen, Getzville, NY (US); Paul James Kubasiewicz, East Amherst, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 10/864,582

(22) Filed: Jun. 10, 2004

Related U.S. Application Data
(60) Provisional application No. 60/485,738, filed on Jul. 10, 2003.

(51) Int. Cl. B05D 3/04

(52) U.S. Cl. 427/181; 427/446

(57) ABSTRACT

A method of forming a composite structure for an ion transport membrane in which a filler substance is applied to one surface of a porous support layer in order to plug pores and prevent coated ion conducting material from penetrating the pores to reduce the amount of gas diffusion. Prior to coating of the surface with layers that may be oxygen ion conducting layers, excess filler substance is removed. After the coating of the one surface, the filler substance is removed from pores.

### CROSS-REFERENCE TO RELATED APPLICATIONS

This application is related to U.S. Provisional Patent Application Ser. No. 60/485,738 which is hereby incorporated by reference as if fully set forth herein.

### U.S. GOVERNMENTAL INTEREST

This invention was made with United States Government support under Cooperative Agreement number DE-FC26-01NT41096 awarded by the U.S. Department of Energy, National Energy Technology Laboratory. The United States Government has certain rights in this invention.

### FIELD OF THE INVENTION

The present invention relates to a method of forming a composite structure for an ion transport membrane in which pores of a porous support layer are filled with a filler substance prior to forming one or more layers of material on the porous support layer to prevent the layers of material from clogging the pores of the support layer.

### BACKGROUND OF THE INVENTION

Ceramic membranes have found increasing application in chemical industries for gas separation and purification. They have the potential of replacing more traditional unit operations such as distillation, evaporation and crystallization. Ion transport membranes can be used to separate oxygen or hydrogen from various feed mixtures. They are formed of ceramics that are capable of conducting oxygen ions or protons at elevated temperature. In case of oxygen ion transport membranes, oxygen ionizes at one surface of the membrane known as a cathode side. The oxygen ions are transported through the membrane to an opposite anode side. At the anode side, the oxygen ions recombine to form elemental oxygen. In recombining, the oxygen ions loose electrons which are used in ionizing oxygen at the cathode side. A typical class of ceramics that are used in forming such membranes are perovskite materials.

The oxygen flux across the ion transport membrane is inversely proportional to the thickness of the membrane. Thus, the thinner the membrane, the higher the flux. However, since the membrane is formed of a brittle ceramic, the membrane must be supported on a porous support. The porous support can be fabricated as the same material as the ion transport membrane or can be fabricated from a different material or even an inert material that does not function in the separation itself. In this regard, the shape of the membrane can be either tubular or that of a flat sheet. A problem in fabricating such membranes is that when layers are applied on to the porous support layer, the pores can become clogged with the material being deposited. As a result, the diffusion resistance of the porous support will increase and the performance of the membrane will consequently decrease.

A similar type of problem has occurred with respect to turbine blade coating. Coatings are applied to turbine blades to provide enhanced resistance to oxidation, corrosion, erosion and other types of environmental degradation. Turbine blades are air cooled and have air passages for passage of air to cool the turbine blade. In order to prevent the air passages from becoming plugged during coating, in U.S. Pat. No. 4,743,462, a fugitive plug is placed in the opening of the cooling passage. In U.S. Pat. No. 6,365,013, a fluid is directed out of the cooling passage for such purposes. It is to be noted that in case of composite ceramic membranes, the pores are from 1 to 10 microns and therefore cannot be fitted with fugitive plugs. Additionally, passing a fluid through a porous supporting structure would disrupt the coating process.

As will be discussed, the present invention provides a method of forming a composite structure for an ion transport membrane in which the support layer is treated to prevent seepage of coating materials into pores located in the support layer.

### SUMMARY OF THE INVENTION

The present invention provides a method of forming a composite structure for an ion transport membrane. In accordance with the method, a filler substance is applied to one surface of a porous support layer having pores such that the filler substance enters the pores. Excess amounts of the filler substance are removed from the one surface of the porous support layer so that the one surface is exposed with the filler substance plugging the pores. At least one layer of material is formed on the one surface of the porous support layer with the filler substance in place, within the pores. The filler substance is removed from the pores after the at least one layer of material is formed on the one surface.

Preferably, the pores can have an average diameter of between about 0.1 and about 500 microns. The filler material can comprise a finally divided powder having an average particle size less than that of the average diameter of the pores. The filler material is applied to the one surface under pressure. The filler material can be starch, graphite, a polymeric substance or mixtures thereof. The particle size of the filler material can be between about 10 percent and about 20 percent of the average pore size.

The filler material, alternatively can be a substance that will dissolve in the solvent. The filler material is removed by dissolving the filler material by applying a solvent to the one surface. The filler material can comprise a liquid which upon curing hardens into a solid. After applying the filler material to the one surface, the liquid can be cured into the solid. The filler material can be a mixture of the liquid and solid particles.

In any embodiment of the present invention the at least one layer of material can be applied by thermally spraying, isopressing or as a slurry, or other appropriate coating processes. The non-porous support layer can be fabricated from a metal and the pores can be non-interconnected, that is the pores do not communicate with one another. Preferably, the pores can be all substantially parallel. The pore support layer, on the other hand, can be fabricated from a ceramic in which the pores are interconnected.

### BRIEF DESCRIPTION OF THE DRAWINGS

While the specification concludes with claims distinctly pointing out the subject matter that Applicants regard as their invention, it is believed that the invention would be better understood when taken in connection with the accompanying drawings in which:

FIG. 1 is a sectional view of a support layer coated with a filler substance in accordance with the method of the present invention;

FIG. 2 is a fragmentary, sectional view of the support layer of FIG. 1 with the filler substance removed from the surface;

FIG. 3 is a sectional view of the porous support layer of FIG. 1 in which a porous layer having a network of interconnected pores is applied to the surface of the support layer and a dense layer of material is applied to the porous layer; and

FIG. 4 is a sectional view of a composite structure that has been prepared in accordance with the present invention.

### DETAILED DESCRIPTION

The present invention provides a method of forming a composite structure for an ion transport membrane. In this regard, the term “composite structure” as used herein and in the claims means a support layer that may or may not be ion conducting that supports at least a dense layer, that is a layer that is gas tight and ion conducting. The dense layer can be applied directly to the support layer or to one or more porous layers applied to the support layer that again may or may not be ion conducting.

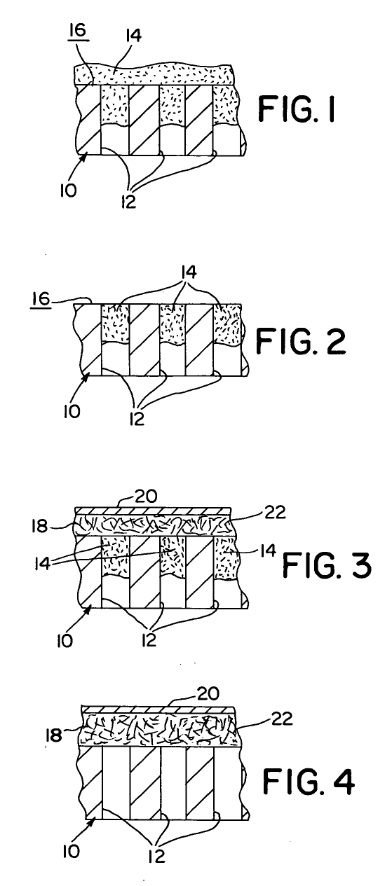

With reference to FIG. 1, the support layer 10 is porous and provides a plurality of pores 12 for passage of oxygen to be separated by a membrane that will hereinafter be applied. In the illustration support layer 10 is a metallic support layer. Pores 12 are cylinders to provide minimum resistance to gas diffusion as compared with porous supports that provide interconnective porous networks. Pores 12 are formed by drilling or by electron beam machining. In order to provide maximum mechanical strength while maintaining optimal gas permeability, pores 12 have a diameter in a range of between 0.1 and about 500 microns and a porosity of between about 5 percent and about 50 percent.

As may be appreciated, if a dense layer were applied directly to support layer 10, pores 12 would in part become clogged with the dense layer material so as not to have the advantage of providing minimum gaseous diffusion resistance. In order to avoid this, filler substance 14 is applied to one surface 16 of porous support layer 10 such that filler substance 14 enters pores 12.

The filler substance can be a finely divided powder of graphite, starch, cellulose, sawdust, or a polymer that is applied to the channels under a pressure of between about 10 and about 150 MPa to form solid plugs. Particle size is preferably in a range from between about 2 and about 100 microns depending upon the diameter of pores 14. Particle size of filler substance 14 is preferably between about 10 percent and about 20 percent of the diameter of pores 12.

Prior to pressing a particulate filler substance 14 in place, porous support layer 10 can be vibrated to facilitate the filling of pores 12.

Filler substance 14 can also be a liquid substance such as an epoxy or glue which would be applied over surface 16. Such liquid substance would penetrate into pores 14 by force of gravity. As may be appreciated, if the viscosity of the liquid substance is too low, the liquid substance will penetrate pores 12 without filling pores 12. On the other hand, if the viscosity is too high the liquid substance will not easily penetrate pores 12. The liquid substance can be cured by for instance loading the coated porous support layer 10 into an oven heated at between about 100° C. for anywhere from between about 5 to and about 50 minutes until solid plugs are formed.

Filler substance 14 can additionally be of a particulate and liquid substance. Such a mixture is advantageous for a very large pores 14. Such a mixture might be applied as a paste.

Since surface 16 is to be coated with either a dense layer or a porous layer excess amounts of filler substance 14 are removed from surface 16 of porous support layer so that surface 16 is exposed and filler substance 14 plugs pores 12. Removal can be accomplished by such means as sandblasting.

Turning to FIG. 3 surface 16 is coated with a porous layer 18 and a dense layer 20 applied to porous layer 18. For instance, layers 18 and 20 could be applied by thermal spray, isopressing or by a slurry/coadial deposition, or by other appropriate coating processes. Dense layer 20 conducts oxygen ions and as a gas tight. Porous layer 18 may or may not be ion conducting and in the illustration consists of an interconnected network of pores 22, that is pores that intersect one another. However, it could have non-interconnected pores, such as pores 12 within support layer 10.

With reference to FIG. 4, filler substance 14 has been removed. In case of a particulate filler substance, filler substance 14 can be removed by placing support layer 12 coated with porous and dense layers 18 and 20 in an oven heated to a temperature of between about 600° C. and about 900° C. If this filler substance 14 were an epoxy or glue or other liquid substance, removal could be accomplished by a solvent. For instance, glues generally can be removed by acetone. The final result is a composite structure in which pores 12 are not filled with filler substance 14.

The following are examples of an application of the present invention to coating a porous support layer. In both examples, the porous support layer is fabricated from MA956 oxide dispersed strengthened alloy obtained from Special Metals Corporation, Huntington, W.Va., United States.

### EXAMPLE 1

Composite elements consisting of a coating deposited on a perforated substrate to simulate a composite structure of an ion transport membrane were fabricated in accordance with prior art techniques. The substrate was a metallic disc about 30 mm in diameter and 1.8 mm in thickness. This was perforated to form straight pores by electron beam drilling. The resultant pores had a diameter of about 120 microns to produce a porosity of about 15 percent.

A plasma spray coating was deposited on the substrate that consisted of a mixed conducting ceramic formed of stronium doped lanthanum chromium iron oxide (“LSCF”). The particle sizes were between about 20 microns and about 30 microns agglomerated from primary particle sizes of between about 0.3 and about 0.5 microns. The coating consisted of two layers, namely a porous layer such as layer 18 and a dense gas separation layer such as dense layer 20. The porous layer 18 was fabricated from LSCF powder blended with 40 percent weight graphite. The thickness of the porous and dense layers was between about 200 and about 250 microns.

The composite element was tested in a test reactor using an 85 percent hydrogen/CO₂ mixture on the anode side and air adjacent the dense layer. The test reactor operated at about 1000° C. Low fluxes of between about 7 and about 8 sccm/cm² were observed. It is believed these low fluxes are the result of the pores becoming plugged.

### EXAMPLE 2

In this example, a porous substrate of a composite structure was formed in the manner of example 1 and was filled with a commercially available glue to prevent any coating from entering the pores. The glue penetrated the pores under the force of gravity. After about 10 minutes the composite structure was placed into an oven at a temperature of about 70° C. and for about 30 minutes to dry the glue within the channels to form plugs. The glue at the surface was then removed by sandblasting at 20 psi using aluminum oxide sand having a particle size of about 100 microns.

The substrate was then coated by plasma spraying a two-layer LSCF coating having dense and porous layers in the manner outlined in Example 1. After completion of the plasma spraying, the composite was placed into a closed container with an appropriate amount of acetone for 60 minutes to remove the glue. The composite structure was rinsed with fresh acetone and was then dried. The resultant composite structure was tested at a temperature of about 1000° C. Higher fluxes as compared to Example 1, of between about 16 and about 18 sccm/cm² were detected.

As will occur to those skilled in the art, numerous additions, changes and omissions can be made without departing from the spirit and the scope of the present invention.

1. A method of forming a composite structure for an ion transport membrane comprising:
applying a filler substance to one surface of a porous support layer having pores such that said filler substance enters said pores;
removing excess amounts of said filler substance from said one surface of said porous support layer;
forming at least one layer of material on said one surface of said porous support layer with said filler substance in place, within the pores; and
removing said filler substance from said pores after said at least one layer of material is formed on said one surface.

2. The method of claim 1, wherein:
said pores have an average diameter of between about 0.1 and about 500 microns; and
said filler material comprises a finely divided power having an average particle size less than that of said average diameter of said pores; and
said filler material is applied to said one surface under pressure.

3. The method of claim 2, wherein:
said filler material comprises starch, graphite, a polymeric substance or mixtures thereof; and
said filler material is removed by heating.

4. The method of claim 2, wherein said particle size of said filler material is between about 10 percent and about 20 percent of said average pore size.

5. The method of claim 1, wherein:
said filler material is a substance that will dissolve in a solvent; and
said filler material is removed by dissolving said filler material by applying a solvent to said one surface.

6. The method of claim 5, wherein said filler material comprises a liquid which upon curing hardens into a solid and after applying said filler material to said surface, said liquid is cured.

7. The method of claim 6 wherein said filler material is a mixture of said liquid and solid particles.

8. The method of claim 1 or claim 2 or claim 5 or claim 6 or claim 7, wherein said at least one layer of material is applied by thermally spraying, isopressing, or as a slurry.

9. The method of claim 8, wherein said porous support layer is fabricated from metal and said pores are non-interconnected.

10. The method of claim 8, wherein said porous support layer is fabricated from a ceramic and said pores are interconnected.
